(19) United States
(12) Patent Application Publication
(10) Pub. No.: US 2015/0268959 A1
(43) Pub. Date: Sep. 24, 2015

(54) PHYSICAL REGISTER SCRUBBING IN A COMPUTER MICROPROCESSOR

(71) Applicant: QUALCOMM Incorporated, San Diego, CA (US)

(72) Inventors: Anil KRISHNA, Raleigh, NC (US); Weidan WU, Durham, NC (US); Sandeep Suresh NAVADA, Knightdale, NC (US); Niket Kumar CHOUDHARY, Raleigh, NC (US); Rodney Wayne SMITH, Raleigh, NC (US)

(73) Assignee: QUALCOMM Incorporated, San Diego, CA (US)

(21) Appl. No.: 14/221,430

(22) Filed: Mar. 21, 2014

(51) Int. Cl. G06F 9/30; G06F 9/38

(52) U.S. Cl. CPC G06F 9/30098; G06F 9/3861

(57) ABSTRACT

Identifying two instructions without intervening potential pipeline flushers that write to the same architected destination register in order to free the physical register corresponding to the older of the two instructions.

### BACKGROUND

Aspects disclosed herein relate to the field of computer microprocessors. More specifically, aspects disclosed herein relate to physical register scrubbing in computer microprocessors.

Most instructions in a computer program produce some output value that is destined for one or more architected registers. These architected destination registers are renamed, in the processor pipeline, to physical registers in order to improve performance by exposing more instruction level parallelism to the processor. How large the instruction window (instructions that have been renamed but not yet committed) can grow is restricted by how many physical registers exist in the microarchitecture. Therefore, the performance of any microarchitecture is tied to the size of the Physical Register File (PRF), which includes entries mapping architected registers to physical registers.

### SUMMARY

Aspects disclosed herein identify two instructions without intervening potential pipeline flushing instructions that write to the same architected destination register in order to free the physical register corresponding to the older of the two instructions.

In one aspect, a method comprises identifying, in a reorder buffer, a first instruction and a second instruction that each write to a first logical register in order to determine that a physical register assigned to the first instruction is not needed for recovery to an earlier state. The first instruction is older than the second instruction.

In another aspect, a method comprises identifying, in a reorder buffer, a first instruction configured to write to a physical register that is not needed for recovery to an earlier state. The physical register is marked as available to be freed, and an indication that the first instruction cannot write to the physical register is stored.

In another aspect, an apparatus comprises a reorder buffer, a plurality of physical registers, and logic. The logic configured to identify, in the reorder buffer, a first instruction configured to write to a first physical register, of the plurality of physical registers that is not needed for recovery to an earlier state. The logic then marks the first physical register as available to be freed, and stores an indication that the first instruction cannot write to the first physical register.

In still another aspect, a non-transitory computer-readable medium stores instructions that, when executed by a processor, cause the processor to identify, in a reorder buffer, a first instruction and a second instruction that each write to a first logical register in order to determine that a physical register assigned to the first instruction is not needed for recovery to an earlier state. The first instruction is older than the second instruction.

### BRIEF DESCRIPTION OF THE SEVERAL VIEWS OF THE DRAWINGS

So that the manner in which the above recited aspects are attained and can be understood in detail, a more particular description of aspects of the disclosure, briefly summarized above, may be had by reference to the appended drawings.

It is to be noted, however, that the appended drawings illustrate only aspects of this disclosure and are therefore not to be considered limiting of its scope, for the disclosure may admit to other aspects.

FIGS. 1A-1C illustrate techniques to implement physical register scrubbing in a computer microprocessor, according to one aspect.

FIG. 2 is a functional block diagram of a processor configured to implement physical register scrubbing, according to one aspect.

FIG. 3 is a flow chart illustrating a method to implement physical register scrubbing in a computer microprocessor, according to one aspect.

FIG. 4 is a flow chart illustrating a method to scrub physical registers, according to one aspect.

FIG. 5 is a flow chart illustrating a method to complete instructions in a microprocessor configured to implement physical register scrubbing, according to one aspect.

FIG. 6 is a block diagram illustrating a system with a computer integrating a processor configured to implement physical register scrubbing, according to one aspect.

### DETAILED DESCRIPTION

Aspects disclosed herein allow a processor to reclaim physical registers more aggressively by identifying physical registers whose values will not be needed for recovery or for connecting consumer instruction(s) of a value to the producer instruction(s) of the value. Generally, aspects disclosed herein identify two instructions that do not have an intervening instruction that may cause a pipeline flush, and that write to the same architected destination register. Once two such instructions are identified, the physical register assigned to the older instruction can be freed.

Conventionally, a processor assigns a unique physical register (PR) to each instruction in order to hold the instruction's production (the result generated by executing the instruction). Physical registers holding a production have two responsibilities. First, the PR must hold the production until all future consumers have consumed the production, and a younger instruction that produces to the same architected destination register is fetched. Second, the PR must hold the production as long as the production may become part of the architected state of the machine. In some microarchitectures, where the consumer can get the production via data forwarding networks, the PR may be free of the first responsibility as soon as a younger producer of the same architected destination is fetched, regardless of whether all consumers have consumed that value. The consumers of the PR that have not yet consumed the production of the PR, in such microarchitectures, may track the producer and receive the produced value via the on-chip result forwarding network.

A PR is relieved of the second responsibility when a younger instruction which produces the same architected destination register commits. It is at that point that the value in the PR is guaranteed to not be needed for mis-speculation recovery. Prior to this point, if the younger instruction were flushed, the value in the PR of the older instruction is live again, and holds the architected register state. Therefore, the physical register of the older instruction cannot be freed until the younger instruction commits.

However, the second responsibility can be overly restrictive when potential recovery points (instructions to which state may recover) are only a subset of all instructions. That is, if it is known that register state need not be recoverable to every instruction, but rather to an identifiable subset of instructions that can cause pipeline flushes (also referred to herein as “potential pipeline flushers”), then maintaining values generated by every instruction in physical registers may become unnecessary. Aspects disclosed herein exploit this relationship to reclaim PRs more aggressively.

For example, and without limitation, if two instructions, A and B, write to the same architected destination register R5, and there is no intervening potential pipeline flusher (PPF) between instructions A and B, then upon recovery to a PPF instruction older than instruction A, the state of R5 prior to instruction A's write may be recovered. Upon recovery to a PPF instruction younger than instruction B, the state of R5 written by instruction B may be recovered. In either case, the state written by instruction A is never recovered to, and the PR written to by instruction A will never be needed for recovery. The PR written to by instruction A can therefore be freed, and returned to the free list of physical registers in the processor.

As used herein, a “potential pipeline flusher” refers to an instruction which causes a processor to speculate such that subsequent instructions may be flushed from the pipeline (and the rename map table (RMT) may need to be rolled back) if the processor's speculation is ultimately incorrect. Examples of potential pipeline flushing instructions include, without limitation, branches, loads, stores, floating point divisions, exception-causing instructions, and the like. In addition, an instruction identified as a potential pipeline flusher upon being decoded may, over time, be reclassified as not being a potential pipeline flusher anymore. A branch, for example, is no longer a potential pipeline flusher once its execution confirms the branch's direction and target prediction performed early in its lifetime through the processor pipeline was correct. Similarly, a load or a store instruction may be reclassified as not being a potential pipeline flusher once it ascertains that it will not need to switch context to a different process, as is the case when the operating system needs to be invoked in order to handle a Translation Lookaside Buffer (TLB) miss or a page fault.

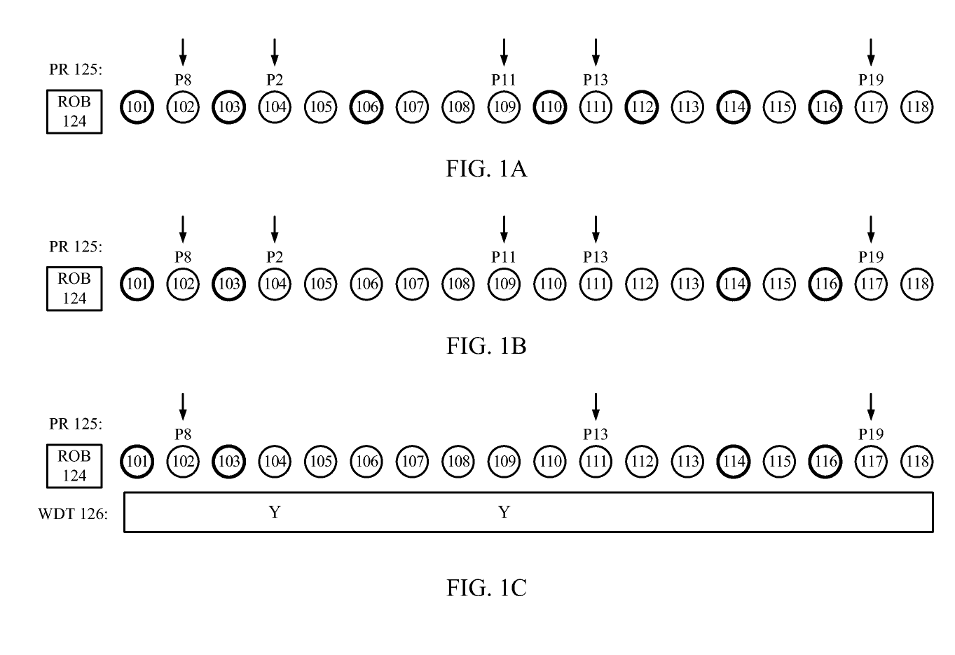

FIG. 1A illustrates techniques to implement physical register scrubbing in a computer microprocessor, according to one aspect. Specifically, FIG. 1A illustrates a plurality of instructions 101-118 in a reorder buffer (ROB) 124 of a CPU (not pictured). A physical register (PR) 125 reflects a physical register assigned to instructions 102, 104, 109, 111, and 117. A PR is not depicted for all instructions 101-118 for the sake of clarity. Therefore, as shown, instruction 102 writes to P8, instruction 104 writes to P2, instruction 109 writes to P11, instruction 111 writes to P13, and instruction 117 writes to P19. In FIGS. 1A-1C, it is assumed that instructions 102, 104, 109, 111, and 117 each write to architected register R5, and the mappings in the physical register file (not pictured) maps physical registers P2, P8, P11, P13, and P19 to architected register R5. The bold outlines of instructions 101, 103, 106, 110, 112, 114, and 116 indicates that each is a potential pipeline flusher (PPF) instruction. Therefore, versions of R5 stored in P2, P8, P11, and P13 are all needed for recovery in case instructions 103, 106, 110, and 112 were mis-speculated, and the CPU needs to roll back the system state.

FIG. 1B illustrates techniques to implement physical register scrubbing in a computer microprocessor, according to one aspect. Specifically, FIG. 1B illustrates the state of the ROB 124 after PPF instructions 106, 110, and 112 resolve, and are no longer PPF instructions. At this point, if the system mis-speculates, the values for architected register R5 stored in P2 and P11 are no longer needed for recovery. Specifically, if instruction 103 mis-speculates, the value of R5 in P8 will be recovered, while if instruction 114 mis-speculates, the value of R5 in P13 will be recovered. In either instance, the values of R5 in P2 and P11 are not needed for system recovery, but only to provide the production of instructions 104 and 109, respectively, to any potential consumers (not shown) of the instructions 104 and 109. However, in some microarchitectures, instructions 104 and 109 can deliver their productions directly to their consumers via on-chip forwarding networks. For microarchitectures having such forwarding networks, the values of R5 in P2 and P11 are no longer needed for any purpose. At this point, physical registers P2 and P11 can be “freed,” such that they may be assigned to new instructions during a subsequent rename operation. By identifying older instructions (104 and 109) that write to the same architected destination register (R5) as a younger instruction (113) and have no intervening PPF instructions (between instructions 104 and 113 and instructions 109 and 113), the physical registers P2 and P11 of the older instructions 104 and 109, respectively, can be freed. Although FIG. 1B depicts an aspect where two physical registers are independently freed, aspects of the disclosure may free zero, one, or more physical registers.

FIG. 1C illustrates techniques to implement physical register scrubbing in a computer microprocessor, according to one aspect. Specifically, FIG. 1C illustrates the state of the ROB 124 after physical registers P2 and P11 have been freed, and are no longer assigned to instructions 104 and 109, respectively. The CPU may now allocate physical registers P2 and P11 to other instructions. However, instructions 104 and 109 may not have even started executing, let alone written their productions to P2 and P11, at the time P2 and P11 are freed. These producer instructions may have previously expected to write to P2 and P11 respectively upon completion of their execution. Additionally, consumer instructions may need to receive the productions of instructions 104 and 109. Indeed, these consumer instructions may have previously expected the productions to be stored in P2 and P11. Therefore, aspects disclosed herein provide a write disallowed table (WDT) 126, which indicates whether or not a given instruction may write to its assigned physical register (regardless of whether the physical register has been freed or not). The WDT 126 may include a number of entries corresponding to the number of entries in the ROB 124. The number of bits per entry in the WDT 126 depends on the maximum number of destination registers a single instruction can write to. Each bit indicates whether or not the instruction is allowed to write to the corresponding assigned physical register. As shown, therefore, entries in WDT 126 corresponding to instructions 104 and 109 have been set to indicate that instructions 104 and 109 cannot write to their now-freed physical registers P2 and P11. Instead, instructions 104 and 109 may communicate their productions to any consumers who have tracked their productions through the on-chip forwarding network.

The illustration of the ROB 124 in FIGS. 1A-1C is an example format intended to facilitate discussion of the techniques disclosed herein. Generally, the ROB 124 may take any format sufficient to maintain an order of the instructions in the ROB 124. The format of the ROB 124 in FIGS. 1A-1C depicts a configuration where the oldest instructions are on the left side of the ROB 124, and the youngest instructions are on the right side of the ROB 124. Generally, an “older” instruction is an instruction that is added to the ROB 124 at an earlier point in time relative to a “younger” instruction.

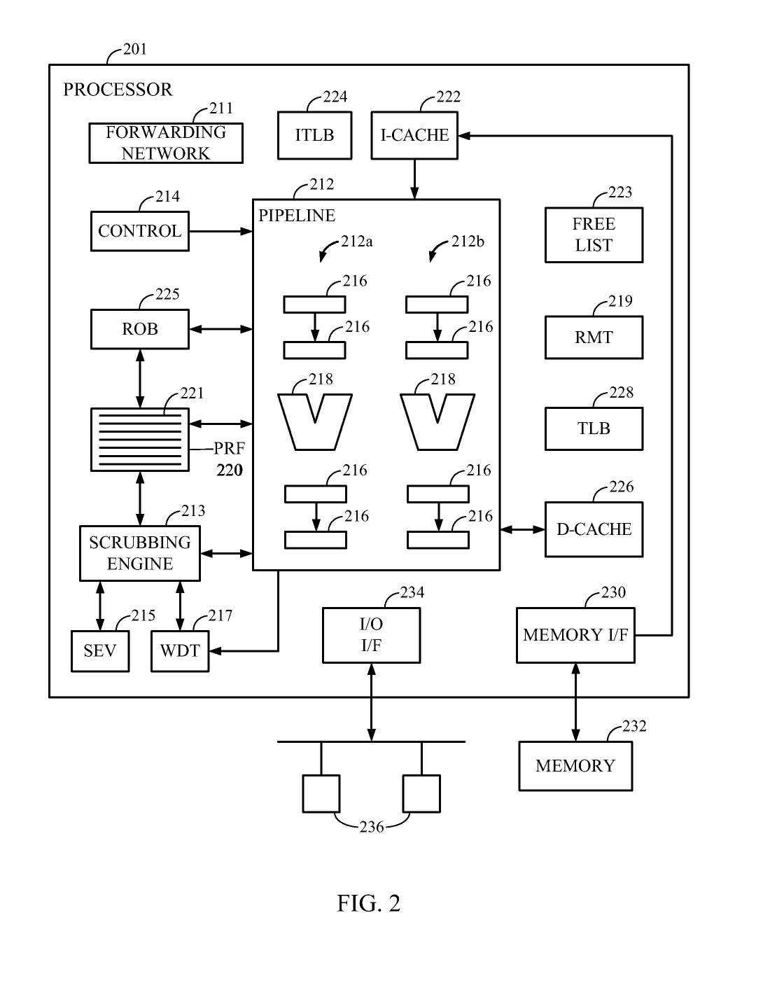

FIG. 2 is a functional block diagram of a processor 201 configured to implement physical register scrubbing, according to one aspect. Generally, the processor 201 executes instructions in an instruction execution pipeline 212 according to control logic 214. The pipeline 212 may be a superscalar design, with multiple parallel pipelines, including, without limitation, parallel pipelines 212a and 212b. The pipelines 212a, 212b include various non-architected registers (or latches) 216, organized in pipe stages, and one or more arithmetic logic units (ALU) 218. A physical register file 220 includes a plurality of architected registers 221. A rename map table (RMT) 219 (also referred to as a most recent writer's table (MRWT)) includes a plurality of entries mapping the architected registers 221 to a physical register (not pictured). A reorder buffer 225 facilitates out-of-order processing in the CPU 201 by maintaining an ordered list of instructions executed by the CPU 201. Instructions are added to the ROB 225 when they are dispatched, and are removed from the ROB 225 when they are completed. Generally, the ROB 225 may take any form suitable to maintain an ordered list of instructions executed by the CPU 201.

The pipelines 212a, 212b may fetch instructions from an instruction cache (I-Cache) 222, while an instruction-side translation lookaside buffer (ITLB) 224 may manage memory addressing and permissions. Data may be accessed from a data cache (D-cache) 226, while a main translation lookaside buffer (TLB) 228 may manage memory addressing and permissions. In some aspects, the ITLB 224 may be a copy of a part of the TLB 228. In other aspects, the ITLB 224 and the TLB 228 may be integrated. Similarly, in some aspects, the I-cache 222 and D-cache 226 may be integrated, or unified. Misses in the I-cache 222 and/or the D-cache 226 may cause an access to higher level caches (such as L2 or L3 cache) or main (off-chip) memory 232, which is under the control of a memory interface 230. The processor 201 may include an input/output interface (I/O IF) 234, which may control access to various peripheral devices 236. The forwarding network 211 is an on-chip data forwarding network that allows a consumer instruction to directly receive the production of a producer instruction by tracking the production. Instead of receiving the production of the producer instruction from a register written to by the producer instruction, the consumer instruction receives the production through the forwarding network 211. Generally, the CPU 201 may include numerous variations, and the CPU 201 shown in FIG. 2 is for illustrative purposes and should not be considered limiting of the disclosure. For example, the CPU 201 may be a graphics processing unit (GPU).

As shown, the CPU 201 also includes a scrubbing engine 213. The scrubbing engine 213 walks the ROB 225 in order to identify “dead” physical registers, and return these registers to the free list 223 of available physical registers. “Dead” physical registers are those registers: (i) that are no longer needed to hold the production of an instruction for future consumer instructions, and (ii) whose production may no longer become part of the architected state of the machine. The scrubbing engine 213 maintains state, which in at least some aspects, comprises the scrubbing engine vector (SEV) 215. Generally, the entries in the SEV 215 correspond to architected registers, and the values for each entry indicate whether or not the scrubbing engine 213 has previously identified an instruction in the ROB 225 configured to write to the corresponding architected register. In at least one aspect, the SEV 215 is an L bit vector, where L is the number of architected registers 221 in the CPU. In another aspect, in lieu of storing a bit for each architected register 221, the SEV 215 stores the different architected registers 221 that are the destinations of instructions that the scrubbing engine 213 encounters while walking the ROB 225.

In at least one other aspect, the SEV 215 may comprise multiple hardware vectors. In such aspects, one SEV may be designated as a “running,” or “live” SEV reflecting the current walk of the scrubbing engine 213. In addition, additional hardware SEVs may be assigned to reflect the state of the running SEV at each time the scrubbing engine 213 encounters a PPF instruction during the walk of the ROB 225. Stated differently, each SEV (other than the running SEV) in the multiple SEV aspect serves as a record of what architected registers were produced between the PPF of the SEV and the next younger PPF. In such aspects, and as described in greater detail below, the scrubbing engine 213 may be able to compare a pair of the multiple SEVs to ensure no PPF instructions exist prior to identifying registers that may be freed.

In some aspects, the scrubbing engine 213 may be executed upon determining that a current count of free physical registers drops below a programmable “scrubbing threshold.” The value for the scrubbing threshold may be stored in a single register (not shown). Generally, any value may be used to set the scrubbing threshold, however, the scrubbing threshold should be small in order to minimize triggering the scrubbing engine too eagerly, which may cause some registers to be freed when in fact the demand for free physical registers was not yet very high. While functionally this is not a problem, it may unnecessarily increase the power consumption due to the scrubbing engine logic. In some aspects, zero is the value for the scrubbing threshold, such that the scrubbing engine 213 is set into action when there are no free registers left for renaming purposes. Setting the value too low (such as zero) has the small downside that the register renaming logic may have to stall waiting for the scrubbing engine to start freeing dead registers. However, many workloads are not very sensitive to the exact value of the scrubbing threshold as long as it is zero or close to zero (between 0 and 10, for example and without limitation).

A write disallowed table (WDT) 217 indicates whether a given instruction can write to its assigned physical register. The WDT 217 includes a number of entries corresponding to the number of entries in the ROB 225. The number of bits per entry in the WDT 217 depends on the maximum number of destination registers a single instruction can write to. Each bit indicates whether or not the instruction is allowed to write to the corresponding assigned physical register. Once invoked, the scrubbing engine 213 sets the SEV 215 to all zeros. The scrubbing engine 213 then walks the ROB 225 at a rate of K entries (where each entry in the ROB corresponds to one instruction) per cycle, starting at the youngest instruction in the ROB 225 moving towards the oldest instruction. K defines the scrubbing bandwidth of the scrubbing engine 213.

While walking the ROB 225, the scrubbing engine 213 identifies the logical destination registers (architected registers 221) of each instruction in the ROB 225. The scrubbing engine 213 then checks the bit corresponding to the architected register 221 in the SEV 215. If the bit corresponding to the architected register in the SEV 215 is 1 (i.e., the scrubbing engine 213 previously identified a younger instruction configured to write to the same architected register), the physical register corresponding to the instruction's production of that logical register is “scrubbed,” or returned to the free list 223. In addition, the bit corresponding to the scrubbed physical register is set to 1 in the WDT 217, indicating that the instruction is not allowed to write to the physical register being scrubbed. While it is possible that the instruction had already written its production to the physical register being scrubbed, it is of no impact to the CPU 201 and the register reclamation techniques described herein. Indeed, the instruction whose register is scrubbed may not have even started execution, let alone finished writing back its results to the physical register. If the bit corresponding to the logical register in the SEV 215 is 0, the scrubbing engine 213 sets the value to 1, indicating that the scrubbing engine 213 has identified an instruction that is configured to write its production to that register. If the scrubbing engine 213 encounters an unresolved PPF instruction while walking the ROB 225, the scrubbing engine 213 sets the SEV 215 to all zeroes, and the scrubbing engine 213 continues to walk the ROB 225. The scrubbing engine 213 may set the SEV 215 to all zeroes upon encountering the unresolved PPF instruction in order to prevent the scrubbing of a register whose state is needed for recovery purposes subsequent to a pipeline flush.

At completion, a producer instruction checks the WDT 217 for each of its destination physical registers. If the entry for the destination physical register is set, the instruction does not write back its results to that physical register. The instruction continues to broadcast its results to its consumers via data forwarding networks (not pictured) on the CPU 201 as usual. In the event of a flush recovery, the scrubbing engine 213 stops, while contents of the WDT 217 younger than the flush causing instruction are invalidated (just as corresponding entries in the ROB 225 are invalidated).

It is possible that the scrubbing engine 213 may take multiple cycles to walk the ROB 225, and it is possible that over those cycles, newer instructions are added to the ROB 225 while older instructions are committed. These dynamic updates to the ROB 225 do not impact the functionality of the scrubbing engine 213.

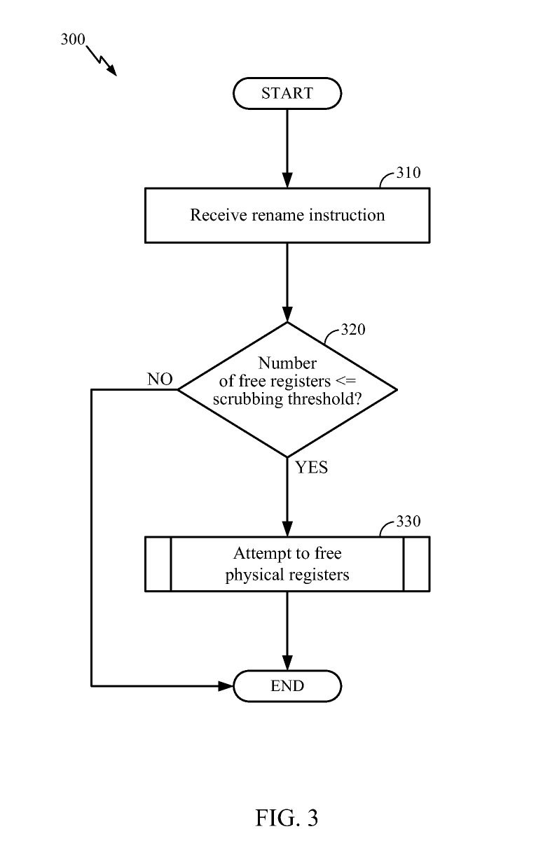

FIG. 3 is a flow chart illustrating a method 300 to implement physical register scrubbing in a computer microprocessor, according to one aspect. Generally, a CPU 201 implements the steps of the method 300 in order to reclaim “dead” physical registers, namely those physical registers whose contents are not needed for system recovery subsequent to a pipeline flush. At step 310, the CPU 201 may receive an instruction whose destination (or destinations) may have to be renamed, that is, where a producer instruction is assigned a physical register corresponding to one or more architected destination register (or registers). Generally, register renaming allows consecutive productions of the same architected registers to have the same “name.” A “name” in this context refers to the uniquely identifiable locations where the producers of the value can produce to, and the consumers of the value can consume from. This location, or “name,” may be called a physical register (although it can also be a name that tracks the bypass path in the processor's execution lanes that would generate the value). However, the number of physical registers available for allocation is finite. As such, aspects disclosed herein implement a programmable “scrubbing threshold” which refers to a count of physical registers. If the number of available (also known as free) physical registers is greater than the scrubbing threshold, the CPU 201 may not attempt to invoke the scrubbing engine 213 in order to reclaim dead physical registers. Therefore, at step 320, the CPU 201, or a designated component thereof, determines whether a number of free registers is less than or equal to than the scrubbing threshold. If the number of free registers is not less than or equal to the scrubbing threshold, the method 300 ends. If the number of free registers is less than or equal to the scrubbing threshold, the CPU 201, or a designated component thereof, may invoke the scrubbing engine 213 at step 330 in order to attempt to free physical registers. Generally, the scrubbing engine 213 looks for two instructions in the ROB 225 that write to the same architected register and that do not have any intervening PPFs between them. If the scrubbing engine 213 identifies two such registers, the scrubbing engine 213 may free the physical register assigned to the older of the two identified instructions.

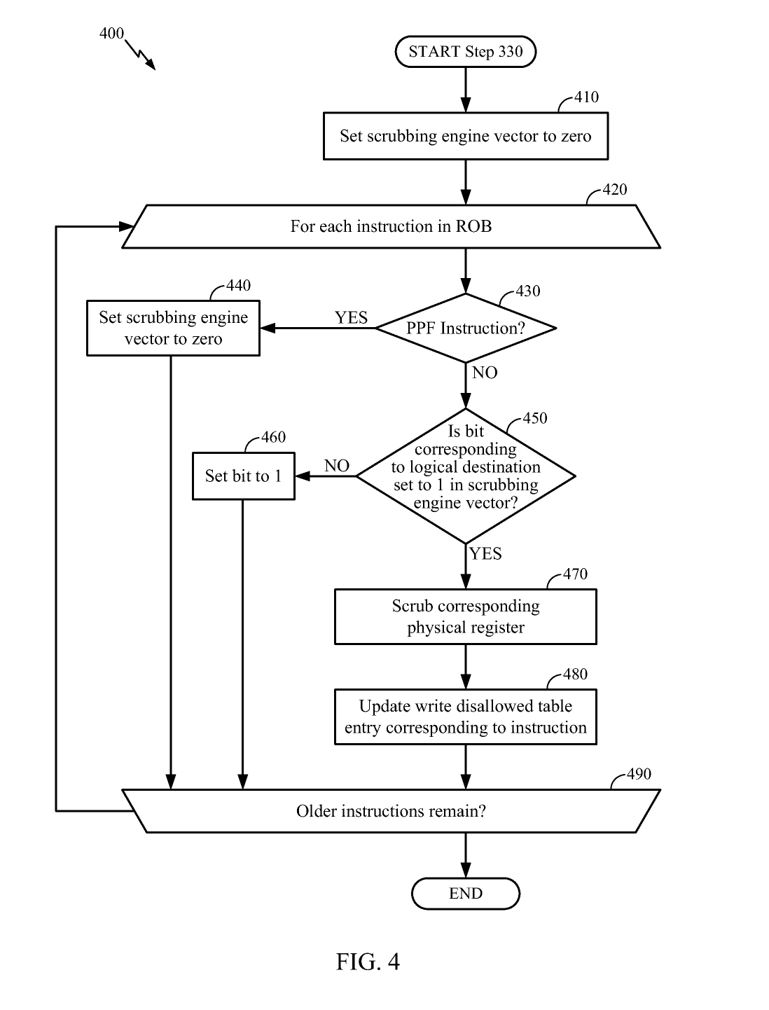

FIG. 4 is a flow chart illustrating a method 400 corresponding to step 330 to scrub physical registers, according to one aspect. Generally, the scrubbing engine 213 (or some other designated component of the CPU 201) performs the steps of the method 400 in order to identify “dead” physical registers, namely physical registers whose values are not needed for recovery in the event of a pipeline flush and not needed to store values for consumers of the production of the instruction writing to the physical register. At step 410, the scrubbing engine 213 sets the scrubbing engine vector 215 to zero, indicating that no instruction has been identified that writes to an architected destination register. At step 420, the scrubbing engine 213 begins executing a loop including steps 430-490 for each entry in the ROB 225, starting with the youngest instruction and moving to the oldest instruction in the ROB 225. At step 430, the scrubbing engine 213 determines whether the current instruction is a potential pipeline flusher (PPF) instruction. PPF instructions are those instructions that cause the CPU 201 to speculate, such as speculative loads, stores, and branches. If the instruction is a PPF instruction, then the scrubbing engine 213 sets the SEV 215 to all zeroes at step 440. The scrubbing engine 213 may reset the SEV 215 to all zeroes in order to prevent the scrubbing engine 213 from later scrubbing a register whose state is needed for recovery purposes subsequent to a pipeline flush.

If the instruction is not a PPF instruction, then at step 450, the scrubbing engine 213 determines whether the bit corresponding to the logical destination register (also referred to as the architected destination register) is set to 1 in the SEV 215. If the bit corresponding to the logical destination register is not set to 1, then, at 460, the scrubbing engine 213 sets this bit to one. In setting the bit corresponding to the logical destination register to one, the scrubbing engine 213 may subsequently identify an older instruction also writing to this destination register, such that the scrubbing engine 213 may then scrub the physical register of the older instruction if no intervening PPFs are encountered. If, at step 450, the bit corresponding to the logical destination register is set to 1 in the SEV 215, the scrubbing engine 213 proceeds to step 470 and scrubs the physical register corresponding to the current instruction. In scrubbing the physical register, the scrubbing engine 213 causes the physical register to be returned to the free list 223. At step 480, the scrubbing engine 213 updates the write disallowed table (WDT) 217 entry corresponding to the current instruction, such that the current instruction knows not to write to its assigned physical register upon completion. Instead, the current instruction can provide its production to consumers via data forwarding networks of the CPU 201. At step 490, the scrubbing engine 213 determines whether any older instructions remain in the ROB 225. If older instructions remain, the scrubbing engine 213 returns to step 420. Otherwise, the method 400 ends.

Although a single SEV 215 has been described as a reference example herein, in some aspects, multiple hardware SEVs 215 may be implemented. In such aspects, one SEV may be designated as a “running,” or “live” SEV reflecting the current walk of the scrubbing engine 213. In addition, an SEV 215 may be assigned to reflect the state of the running SEV at each time the scrubbing engine 213 encounters a PPF instruction during the walk of the ROB 225. For example, if the scrubbing engine 213 identifies a first PPF, the scrubbing engine 213 may save the state of the running SEV to a first SEV corresponding to the first PPF, and reset the running SEV to all zeroes. Doing so may help the scrubbing engine 213 speed up the identification of registers that may be freed at the time of the next scrubbing, as the scrubbing engine 213 would not have to rebuild the running SEV by walking the entire ROB 225, if, for example, a PPF instruction resolves and is no longer a PPF instruction.

For example, the scrubbing engine 213 may identify three PPF instructions, PPF0, PPF1, and PPF2 (in order from oldest to youngest) in the ROB 225. If PPF1 later resolves, the scrubbing engine 213 may update SEV0 (corresponding to PPF0), because the values in SEV0 may change if the scrubbing engine 213 were to re-walk the ROB 225. However, instead of re-walking the ROB 225, the change may be reflected by bit-wise ORing SEV0 and SEV1. The scrubbing engine 213 may then save the result in SEV0. Additionally, the scrubbing engine 213 may identify architected registers between PPF0 and PPF2 (except the youngest production of those architected registers) whose physical registers may be freed by performing a bit-wise AND of the unmodified SEV0 (the state of SEV0 prior to ORing SEV0 and SEV1) and SEV1. Once the scrubbing engine 213 identifies an architected register whose physical register may be freed by ANDing SEV0 and SEV 1, the scrubbing engine 213 may then walk the ROB 225 between PPF0 and PPF2 when PPF1 resolves in order to identify the actual physical registers to be freed. Furthermore, if the bit-wise AND of SEV0 and SEV1 indicates no freeing is possible, (e.g., the bit-wise AND is all zeroes), no walk of the ROB 225 is needed.

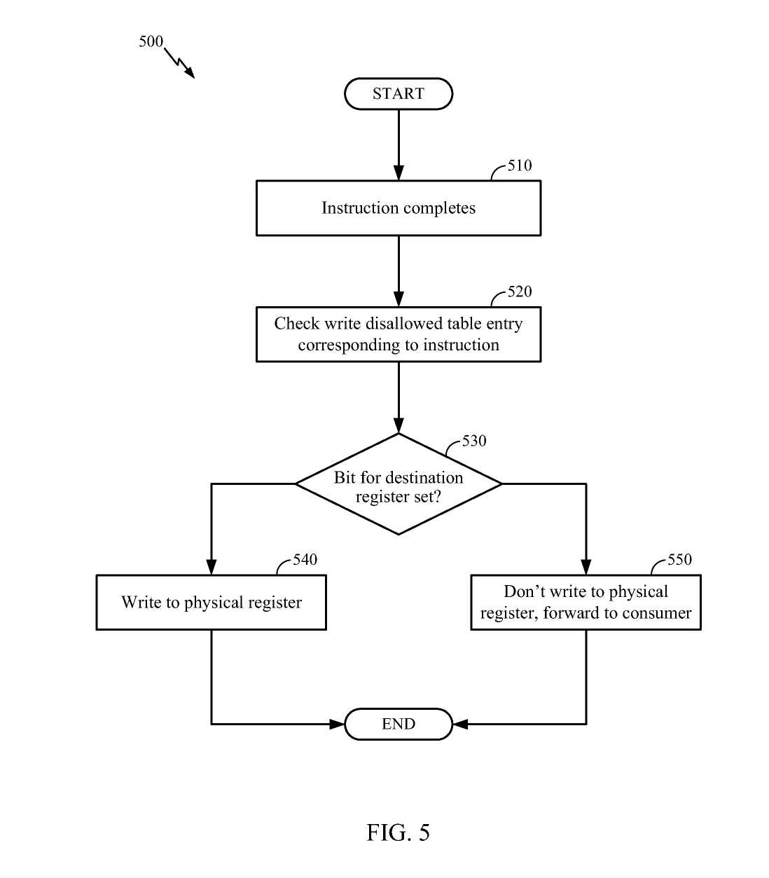

FIG. 5 is a flow chart illustrating a method 500 to complete instructions in a microprocessor configured to implement physical register scrubbing, according to one aspect. Generally, the steps of the method 500 allow the production of a completed instruction to be consumed by one or more consumers, even if a physical register corresponding to the instruction has been scrubbed by the scrubbing engine 213. At step 510, an instruction completes execution. At step 520, the instruction references its own entry in the WDT 217 in order to determine whether it can write to its physical register. At step 530, the instruction determines whether the bit for its physical register is set. If the bit is not set, then the instruction may write to its assigned physical register at step 540. If the bit is set, then the instruction, at step 550, does not write to its assigned physical register. The instruction continues to forward its production to one or more consumers via the forwarding network 211. In some aspects, a given instruction may produce output for more than one physical register. However, the scrubbing engine 213 may scrub zero, one, or more of these physical registers. In such an event, the entry corresponding to the instruction in the WDT 217 includes a bit for each destination physical register, and each bit reflects whether the instruction can write to each destination physical register. Therefore, a given instruction may be able to write to one or more of its destination physical registers that have not been scrubbed, while not being able to write to one or more destination physical registers that have been scrubbed.

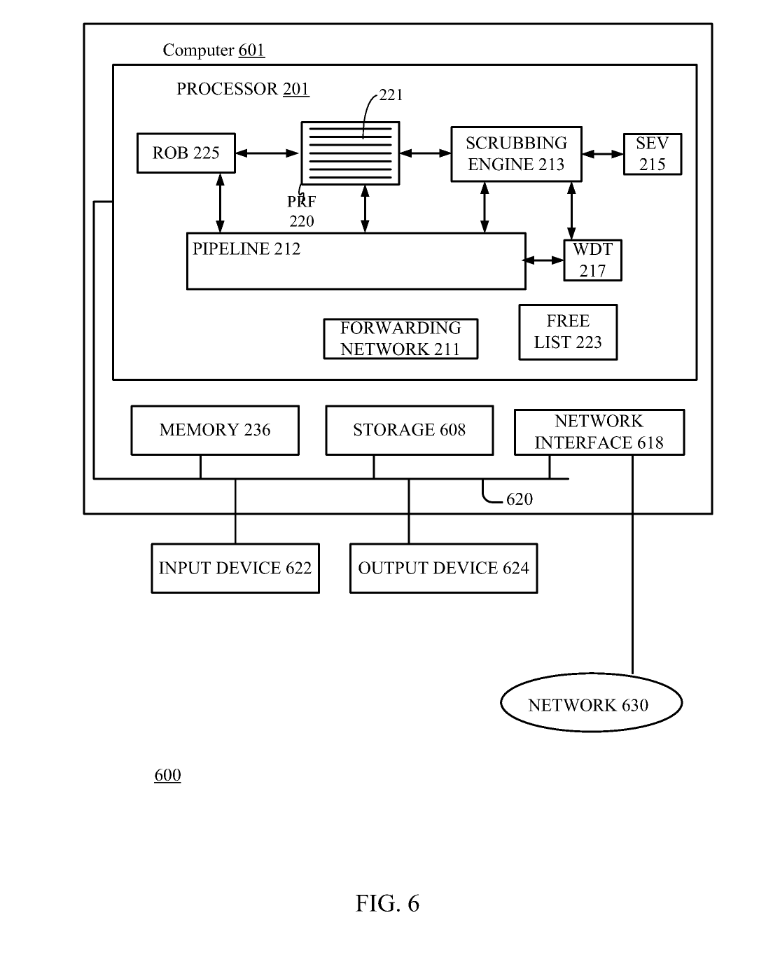

FIG. 6 is a block diagram illustrating a system 600 with a computer 601 integrating the processor 201 configured to implement physical register scrubbing, according to one aspect. The networked system 600 includes the computer 601. The computer 601 may also be connected to other computers via a network 630. In general, the network 630 may be a telecommunications network and/or a wide area network (WAN). In a particular embodiment, the network 630 is the Internet. Generally, the computer 601 may be any computing device which includes a processor configured to implement physical register scrubbing, including, without limitation, a desktop computer, a laptop computer, a tablet computer, and a smart phone.

The computer 601 generally includes the processor 201 connected via a bus 620 to the memory 236, a network interface device 618, a storage 608, an input device 622, and an output device 624. The computer 601 is generally under the control of an operating system (not shown). Any operating system supporting the functions disclosed herein may be used. The processor 201 is included to be representative of a single CPU, multiple CPUs, a single CPU having multiple processing cores, and the like. The network interface device 618 may be any type of network communications device allowing the computer 601 to communicate with other computers via the network 630.

As previously discussed in greater detail with reference to FIG. 2, the processor 201 includes the scrubbing engine 213 that is configured to free physical registers 221 in a physical register file 220. The scrubbing engine 213 is generally configured to walk the ROB 225 in order to identify dead physical registers, and return these registers to the free list 223 of available physical registers. “Dead” physical registers are those registers: (i) that are no longer needed to hold the production of an instruction for future consumer instructions, and (ii) whose production may no longer become part of the architected state of the machine. The scrubbing engine 213 maintains state, which may comprise the scrubbing engine vector (SEV) 215. The write disallowed table (WDT) 217 indicates whether a given instruction can write to its assigned physical register. The forwarding network 211 is an on-chip data forwarding network that allows a consumer instruction to directly receive the production of a producer instruction by tracking the production. Instead of receiving the production of the producer instruction from a register written to by the producer instruction, the consumer instruction receives the production through the forwarding network 211.

The storage 608 may be a persistent storage device. Although the storage 608 is shown as a single unit, the storage 608 may be a combination of fixed and/or removable storage devices, such as fixed disc drives, solid state drives, SAN storage, NAS storage, removable memory cards or optical storage. The memory 236 and the storage 608 may be part of one virtual address space spanning multiple primary and secondary storage devices.

The input device 622 may be any device for providing input to the computer 601. For example, a keyboard and/or a mouse may be used. The output device 624 may be any device for providing output to a user of the computer 601. For example, the output device 624 may be any conventional display screen or set of speakers. Although shown separately from the input device 622, the output device 624 and input device 622 may be combined. For example, a display screen with an integrated touch-screen may be used.

Advantageously, aspects disclosed herein identify and free “dead” physical registers, namely those registers that are not needed for recovery or for connecting consumer instruction(s) of a value to the producer instruction(s) of the value. To identify the dead physical registers, aspects disclosed herein identify two instructions that write to the same destination architected register. If there are no intervening instructions which may cause pipeline flushes (also referred to herein as potential pipeline flushers), the physical register corresponding to the older instruction may be freed, as its value is no longer necessary for recovery or connecting consumers to the production of the instruction.

A number of aspects have been described. However, various modifications to these aspects are possible, and the principles presented herein may be applied to other aspects as well. The various tasks of such methods may be implemented as sets of instructions executable by one or more arrays of logic elements, such as microprocessors, embedded controllers, or IP cores.

The foregoing disclosed devices and functionalities may be designed and configured into computer files (e.g. RTL, GDSII, GERBER, etc.) stored on computer readable media. Some or all such files may be provided to fabrication handlers who fabricate devices based on such files. Resulting products include semiconductor wafers that are then cut into semiconductor die and packaged into a semiconductor chip.

The various illustrative methods, algorithms, modules, logical blocks, circuits, and tests and other operations described in connection with the configurations disclosed herein may be implemented as electronic hardware, computer software, or combinations of both. Such methods, algorithms, modules, logical blocks, circuits, and operations may be implemented or performed with a general purpose processor, a digital signal processor (DSP), an ASIC or ASSP, an FPGA or other programmable logic device, discrete gate or transistor logic, discrete hardware components, or any combination thereof designed to produce the configuration as disclosed herein. For example, such a configuration may be implemented at least in part as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a general purpose processor or other digital signal processing unit. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. A software module may reside in a storage medium such as RAM (random-access memory), ROM (read-only memory), nonvolatile RAM (NVRAM) such as flash RAM, erasable programmable ROM (EPROM), electrically erasable programmable ROM (EEPROM), registers, hard disk, a removable disk, or a CD-ROM; or in any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

It is noted that the various methods disclosed may be performed by an array of logic elements such as a processor, and that the various elements of an apparatus as described herein may be implemented as modules designed to execute on such an array. As used herein, the term “module” or “sub-module” can refer to any method, apparatus, device, unit or computer-readable data storage medium that includes computer instructions (e.g., logical expressions) in software, hardware or firmware form. It is to be understood that multiple modules or systems can be combined into one module or system and one module or system can be separated into multiple modules or systems to perform the same functions. When implemented in software or other computer-executable instructions, the elements of a process are essentially the code segments to perform the related tasks, such as with routines, programs, objects, components, data structures, and the like. The term “software” should be understood to include source code, assembly language code, machine code, binary code, firmware, macrocode, microcode, any one or more sets or sequences of instructions executable by an array of logic elements, and any combination of such examples. The program or code segments can be stored in a processor readable medium or transmitted by a computer data signal embodied in a carrier wave over a transmission medium or communication link.

The implementations of methods, schemes, and techniques disclosed herein may also be tangibly embodied (for example, in tangible, computer-readable features of one or more computer-readable storage media as listed herein) as one or more sets of instructions executable by a machine including an array of logic elements (e.g., a processor, microprocessor, microcontroller, or other finite state machine). The term “computer-readable medium” may include any medium that can store or transfer information, including volatile, nonvolatile, removable, and non-removable storage media. Examples of a computer-readable medium include an electronic circuit, a semiconductor memory device, a ROM, a flash memory, an erasable ROM (EROM), a floppy diskette or other magnetic storage, a CD-ROM/DVD or other optical storage, a hard disk or any other medium which can be used to store the desired information, a fiber optic medium, a radio frequency (RF) link, or any other medium which can be used to carry the desired information and can be accessed. The computer data signal may include any signal that can propagate over a transmission medium such as electronic network channels, optical fibers, air, electromagnetic, RF links, etc. The code segments may be downloaded via computer networks such as the Internet or an intranet. In any case, the scope of the present disclosure should not be construed as limited by such aspects.

Each of the tasks of the methods described herein may be embodied directly in hardware, in a software module executed by a processor, or in a combination of the two. In a typical application of an implementation of a method as disclosed herein, an array of logic elements (e.g., logic gates) is configured to perform one, more than one, or even all of the various tasks of the method. One or more (possibly all) of the tasks may also be implemented as code (e.g., one or more sets of instructions), embodied in a computer program product (e.g., one or more data storage media such as disks, flash or other nonvolatile memory cards, semiconductor memory chips, etc.), that is readable and/or executable by a machine (e.g., a computer) including an array of logic elements (e.g., a processor, microprocessor, microcontroller, or other finite state machine). The tasks of an implementation of a method as disclosed herein may also be performed by more than one such array or machine.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A method, comprising:
identifying, in a reorder buffer, a first instruction and a second instruction that each write to a first logical register in order to determine that a physical register assigned to the first instruction is not needed for recovery to an earlier state, wherein the first instruction is older than the second instruction.

2. The method of claim 1, further comprising:
prior to identifying the first and second instructions, determining that a count of physical registers available for renaming is below a programmable threshold.

3. The method of claim 1, further comprising:
marking the physical register as available to be freed; and
storing an indication that the first instruction cannot write to the physical register.

4. The method of claim 1, further comprising:
upon detecting a pipeline flushing instruction in the reorder buffer:
marking the physical register as not available to be freed; and
storing an indication that the first instruction can write to the physical register.

5. The method of claim 1, further comprising:
broadcasting a production of the first instruction to a consumer of the production of the first instruction, wherein the consumer was previously configured to read the production of the first instruction from the physical register assigned to the first instruction.

6. The method of claim 1, wherein a potential pipeline flushing instruction does not exist between the first instruction and the second instruction in the reorder buffer.

7. The method of claim 1, wherein determining that the first instruction and the second instruction each write to the first logical register comprises:
referencing the reorder buffer to determine that the second instruction writes to the first logical register;
storing an indication that an existing instruction writes to the first logical register;
referencing the reorder buffer to determine that the first instruction writes to the first logical register; and
referencing the indication to determine that the existing instruction writes to the first logical register.

8. A method, comprising:
identifying, in a reorder buffer, a first instruction configured to write to a physical register that is not needed for recovery to an earlier state;
marking the physical register as available to be freed; and
storing an indication that the first instruction cannot write to the physical register.

9. The method of claim 8, wherein the first instruction is further configured to write to a logical register, wherein identifying the first instruction comprises:
identifying a second instruction, younger than the first instruction, that is configured to write to the logical register.

10. The method of claim 9, further comprising:
determining that a potential pipeline flushing instruction does not exist between the first and second instructions in the reorder buffer.

11. The method of claim 9, further comprising:
upon determining that a potential pipeline flushing instruction exists between the first and second instructions in the reorder buffer:
marking the physical register as not available to be freed; and
storing an indication that the first instruction can write to the physical register.

12. The method of claim 8, further comprising:
prior to identifying the first instruction, determining that a count of physical registers available for renaming is below a programmable threshold.

13. The method of claim 8, further comprising:
broadcasting a production of the first instruction to a consumer of the production of the first instruction, wherein the consumer was previously configured to read the production of the first instruction from the physical register assigned to the first instruction.

14. An apparatus, comprising:
a reorder buffer;
a plurality of physical registers; and
logic configured to:
identify, in the reorder buffer, a first instruction configured to write to a first physical register, of the plurality of physical registers, that is not needed for recovery to an earlier state;
mark the first physical register as available to be freed; and
store an indication that the first instruction cannot write to the first physical register.

15. The apparatus of claim 14, wherein the logic is further configured to:
prior to identifying the first and second instructions, determine that a count of the plurality of physical registers available for renaming is below a programmable threshold.

16. The apparatus of claim 14, wherein the first instruction is further configured to write to a logical register, wherein the logic is further configured to:
identify a second instruction, younger than the first instruction, that is configured to write to the logical register.

17. The apparatus of claim 16, wherein the logic is further configured to:
determine that a potential pipeline flushing instruction does not exist between the first and second instructions in the reorder buffer.

18. The apparatus of claim 16, wherein the logic is further configured to:
upon determining that a potential pipeline flushing instruction exists between the first and second instructions in the reorder buffer:
mark the first physical register as not available to be freed; and
store an indication that the first instruction can write to the first physical register.

19. The apparatus of claim 14, wherein the first instruction broadcasts a production of the first instruction to a consumer of the production of the first instruction, wherein the consumer was previously configured to read the production of the first instruction from the first physical register.

20. The apparatus of claim 14, further comprising a state vector, wherein the logic to determine that the first instruction and the second instruction each write to the first logical register comprises logic configured to:
reference the reorder buffer to determine that the second instruction writes to the first logical register;
store an indication in the state vector an existing instruction writes to the first logical register;
reference the reorder buffer to determine that the first instruction writes to the first logical register; and
reference the state vector to determine that the existing instruction writes to the first logical register.

21. A non-transitory computer-readable medium storing instructions that, when executed by a processor, cause the processor to:
identify, in a reorder buffer, a first instruction and a second instruction that each write to a first logical register in order to determine that a physical register assigned to the first instruction is not needed for recovery to an earlier state, wherein the first instruction is older than the second instruction.

22. The non-transitory computer-readable medium of claim 21, wherein a potential pipeline flushing instruction does not exist between the first instruction and the second instruction in the reorder buffer, the computer-readable medium further comprising instructions that, when executed by the processor, cause the processor to:
prior to identifying the first and second instructions, determine that a count of physical registers available for renaming is below a programmable threshold.

23. The non-transitory computer-readable medium of claim 21, further comprising instructions that, when executed by the processor, cause the processor to:
mark the physical register as available to be freed; and
store an indication that the first instruction cannot write to the physical register.

24. The non-transitory computer-readable medium of claim 21, further comprising instructions that, when executed by the processor, cause the processor to:
upon detecting a pipeline flushing instruction in the reorder buffer:
mark the physical register as not available to be freed; and
store an indication that the first instruction can write to the physical register.

25. The non-transitory computer-readable medium of claim 21, further comprising instructions that, when executed by the processor, cause the processor to:
broadcast a production of the first instruction to a consumer of the production of the first instruction, wherein the consumer was previously configured to read the production of the first instruction from the physical register assigned to the first instruction.
